(19) United States
(12) Patent Application Publication
(10) Pub. No.: US 2012/0239607 A1
(43) Pub. Date: Sep. 20, 2012

(54) DEVICE AND METHOD FOR RECOGNIZING USER BEHAVIOR

(75) Inventors: JIA RAO, Beijing (CN); Weili Zhang, Beijing (CN); Tao Wu, Beijing (CN); Chenghai Li, Beijing (CN)

(73) Assignee: NEC (China) Co., Ltd., Beijing (CN)

(21) Appl. No.: 13/348,017

(22) Filed: Jan. 11, 2012

(30) Foreign Application Priority Data
Mar. 18, 2011 (CN) 201110077602.3

(51) Int. Cl. G06N 5/02

(52) U.S. Cl. 706/58

(57) ABSTRACT

A device for recognizing user behavior is provided, which includes: a position data receiving unit configured to receive user position data and adjust the data based on time to obtain user position data in time series; a data pretreating unit configured to pretreat the user position data in time series; a feature vector extracting unit configured to extract a feature vector for recognizing a type of a user activity according to the pretreated user position data; and a user behavior recognizing unit configured to recognize the type of a user activity according to the feature vector extracted by the feature vector extracting unit and to obtain behavior features of the user. A method for recognizing user behavior is also provided. Deep level behavior features of the user can be obtained, such that the recognition result for each user can be more accurate and richer.

### FIELD OF THE INVENTION

The invention relates to the field of data analysis, and more particularly, to a device and method for recognizing user behavior based on position data.

### BACKGROUND OF THE INVENTION

With the rapid development and prevalence of positioning technology, such as global satellite positioning systems and mobile phone positioning techniques based on wireless cellular networks, it is possible to identify surrounding geographical environments efficiently. Such position information can be used not only in positioning, navigation and some position-based services, but also in representation of historical user behavior in geographical space. For example, a historical trajectory of a user can be represented by joining the isolated position points of the user into a line in is chronological order. The life regularity and behavioral features of the user can be reflected by accumulating a number of historical trajectories. Further, the life regularity and behavioral features (such as hot spots, classical travel routes, traffic conditions, etc.) of people within a particular region can be obtained by analyzing a large set of user data.

Among a number of current wireless positioning techniques, Global Positioning System (GPS) becomes popular thanks to its advantages such as large coverage, high positioning accuracy, short positioning time and low positioning dependency. The emergence of various vehicle-mounted GPS, handheld GPS and GPS-enabled smart phones provides a more convenient way for acquiring position and recording trajectory. The trajectory data obtained by GPS plays an important role in a variety of applications, e.g., to assist in interpretation of individual behavior and social regularity. From the perspective of data sources, there are two directions of interpretations, one based on individual user trajectory data and the other based on multi-user trajectory data.

The interpretation based on individual user trajectory data means that a user can record his/her travel routes, movement experience, daily life and working trajectory without disturbing his/her life. This trajectory data, in combination with an existing geographical information database and an electronic map, can provide the individual user with services such as assisting the user to recall his/her past more effectively, share his/her life experience with friends more conveniently and understand his/her own life regularity, as well as personalized services.

The trajectory data for a single user can reflect individual life regularity, while a set of trajectory data for multiple users can be used to represent the life style of people living in a community or even in a city to recognize user behavior. Behavior at fixed destinations, such as dinner, shopping and sports, also contains interpretation of user behavior during a trip, e.g., for indicating the transportation means for the user (by car, by public transportation or by bicycle) and predicting the destination possibly selected by the user.

However, there is a problem in technical implementation to recognize user behavior and thus obtain life styles of users in a particular region by interpreting trajectory data. No matter which positioning scheme is used, there is a positioning error such that it is impossible to perfectly match the accurate position of a user with a Point of Interest (POI) in a digital electronic map. Thus, the positioning can only be accurate for some large city region such as, e.g., Central Business District (CBD), ZhongGuanCun and the like. Therefore, it is not possible to accurately recognize user behavior, but only to generally analyze the trend of user position distribution. As a result, the trajectory data of a single user cannot be accurately interpreted and thus the detailed behavior pattern of an individual cannot be obtained. Also, it is not possible to obtain the behavior patterns of people in a community or even a city by such analysis.

There is a prior art method for processing user data, in which various user data information is obtained based on changes in position information of a user and then is subjected to a classified statistical process based on geographical distribution, so as to analyze user behavior and habit. This method mainly comprises the following steps. First, the position information of the user is obtained which contains user identification and a position region where the user is located. Then, based on a defined conditional criterion, a user identification satisfying the conditional criterion can be found from a historical record of position information. Finally, user information can be extracted based on the found user identification, and user data can be issued based on the user information. The specific operation process of this method will be detailed below.

FIG. 1 shows a user trajectory distributed over time scope and region scope. As shown in FIG. 1, the irregular shape represents the time and region scopes in which the user trajectory is distributed and the rectangular block represents the time and region scopes to be analyzed. A number of points represent the position points of users. The abscissa denotes region while the ordinate denotes time. In the example shown in FIG. 1, points 3 and 4 are user position points within the scope and points 3 and 4 are user position points outside the scope.

The user position points within the scope (e.g., points 3 and 4) are formed into a set containing identification information of users, such as cell phone number, as shown in Table 1 below.

TABLE 1

| Record | Region | Time | User ID |
|---|---|---|---|
| Point 1 | >Region 1 & | >Time 2 | User 3 |
| | <Region 2 | | |
| Point 2 | >Region 2 | >Time 1 & | User 3 |
| | | <Time 2 | |
| Point 3 | >Region 1 & | >Time 1 & | User 1 |
| | <Region 2 | <Time 2 | |
| Point 4 | >Region 1 & | >Time 1 & | User 2 |
| | <Region 2 | <Time 2 | |
| . . . | . . . | . . . | . . . |

Then, user information can be extracted from a user information database based on the found user identifications, as shown in Table 2 below.

TABLE 2

| User ID | Age | Gender | . . . |
|---|---|---|---|
| User 1 | 20 | Female | . . . |
| User 2 | 18 | Female | . . . |
| User 3 | 30 | Male | . . . |
| . . . | . . . | . . . | . . . |

Thus, there are two users within the scope, User 1 and User 2, who are a 20 year old female and an 18 year old female, respectively.

Finally, classified statistical processing can be carried out based on the found user information in combination with a user data set, and the user habit behavior data within the region can be issued. In this way, the user feature distribution within the time and region scopes can be obtained, as shown in Table 3 below.

TABLE 3

| Item | Statistics | Feature | . . . |
|---|---|---|---|
| Age | 16-20: 2 | Young People | . . . |
| | 20-30: 0 | Favor | |
| | 30-40: 0 | | |
| Gender | Female: 2 | Female Favor | . . . |
| | Male: 0 | | |
| . . . | . . . | . . . | . . . |

It can be seen that the above defined time and region scopes have the following features: young people are in the majority with respect to age; and females are in the majority with respect to gender. Thus, it can be concluded that the above defined time and region scopes have a young female favor.

However, the above method simply applies classified statistical processing on the discrete user position data based on distribution. The user statistical result based on geographical distribution cannot represent the real behavior of the user and thus cannot provide sufficient information for recommending Points of Interest (POIs) for users located in the region. According to this classified statistical processing method, it is not possible to accurately represent the real intention and behavior of a user, and it is very indeterminate. Further, such analysis in a superficial level sense cannot provide sufficient information for other users and cannot provide excellent proposals for city planning.

### SUMMARY OF THE INVENTION

In order to solve the above problem, the present invention provides a device and method for recognizing user behavior based on position information in time series. First, position information in time series for a user trip is subjected to data pretreating to extract a trip chain and an activity region as well as optional types of activities. Then, a feature for recognizing activity type is extracted from the temporal and spatial factors of the trip chain and activity region, with the resulting feature vector input to a classifier. Finally, a pair wise classifier is established based on Support Vector Machine (SVM) to select the activity type from the set of optional activities by a classifier voting approach. In this way, the behavior features, i.e., trip feature and activity feature, of the user can be obtained.

According to an aspect of the present invention, a device for recognizing user behavior is provided, which comprises: a position data receiving unit configured to receive user position data and adjust the data based on time to obtain user position data in time series; a data pretreating unit configured to pretreat the user position data in time series; a feature vector extracting unit configured to extract a feature vector for recognizing a type of a user activity according to the pretreated user position data; and a user behavior recognizing unit configured to recognize the type of a user activity according to the feature vector extracted by the feature vector extracting unit and to obtain behavior features of the user.

Preferably, the user position data in time series comprise user identification information, geographical position information, and time information.

Preferably, the data pretreating unit is configured to obtain a user trip chain and user activity regions from the user position data in time series, and to obtain user activity optional positions in connection with Point of Interest information of a digital electronic map.

Preferably, the feature vector extracted by the feature vector extracting unit comprises time-based and space-based vectors for a user trip chain and time-based and space-based vectors for a user activity.

Preferably, the time-based vector for a user trip chain comprises a ratio of start time of the trip chain to a whole day, a ratio of duration of the trip chain to a whole day, a ratio of start time of a main activity to a whole day, a ratio of duration of a main activity to a whole day, a ratio of duration of all the activities to duration of the trip chain, a ratio of an average of duration of all the activities to duration of the trip chain, a standard deviation of a ratio of duration of distributed activities to duration of the trip chain, and a ratio of duration of a main activity to duration of all the activities in the trip chain.

Preferably, the space-based vector for a user trip chain comprises a ratio of a length of the trip chain to a maximal length of the trip chain, a ratio of a radius of the trip chain to a length of the trip chain, a ratio of a distance a main activity departs from home to a length of the trip chain, a ratio of an average of distances between the activities to a length of the trip chain, and a standard deviation of distances between the activities.

Preferably, the time-based vector for a user activity comprises a ratio of start time of an activity to a whole day, a ratio of duration of an activity to a whole day, a ratio of a difference between start time of an activity and start time of the trip chain to duration of the trip chain, a ratio of duration of an activity to duration of the trip chain, a ratio of a difference between start time of an activity and end time of the previous activity to duration of the trip chain, a ratio of a difference between end time of an activity and start time of the next activity to duration of the trip chain, a ratio of duration of an activity to duration of a main activity, a ratio of a difference between start time of an activity and end time of a main activity to duration of the trip chain, and a ratio of a difference between start time of a main activity and end time of an activity to duration of the trip chain.

Preferably, the space-based vector for a user activity comprises a ratio of a distance an activity departs from home to a length of the trip chain, a ratio of distances between an activity and the previous activity to a length of the trip chain, a ratio of distances between an activity and the next activity to a length of the trip chain, a ratio of a difference between distance from an activity to home and distance from a main activity to home to a length of the trip chain, and a ratio of a difference between distance an activity departs from home and distance a main activity departs from home to a length of the trip chain.

Preferably, the user behavior recognizing unit comprises a classifier based on Support Vector Machine.

Preferably, the device for recognizing user behavior further comprises: a user behavior gathering unit configured to associate behavior features of a user with the user's information through user identification, and to gather feature data of a plurality of users in a certain region to obtain feature information of the region.

According to another aspect of the present invention, a method for recognizing user behavior is provided, which comprises: receiving user position data and adjusting the data based on time to obtain user position data in time series; pretreating the user position data in time series; extracting a feature vector for recognizing a type of a user activity according to the pretreated user position data; and recognizing the type of a user activity according to the feature vector so as to obtain behavior features of the user.

Preferably, the user position data in time series comprise user identification information, geographical position information, and time information.

Preferably, the step of pretreating comprises obtaining a user trip chain and user activity regions from the user position data in time series, and obtaining user activity optional positions in connection with Point of Interest information of a digital electronic map.

Preferably, the feature vector comprises time-based and space-based vectors for a user trip chain and time-based and space-based vectors for a user activity.

Preferably, the time-based vector for a user trip chain comprises a ratio of start time of the trip chain to a whole day, a ratio of duration of the trip chain to a whole day, a ratio of start time of a main activity to a whole day, a ratio of duration of a main activity to a whole day, a ratio of duration of all the activities to duration of the trip chain, a ratio of an average of duration of all the activities to duration of the trip chain, a standard deviation of a ratio of duration of distributed activities to duration of the trip chain, and a ratio of duration of a main activity to duration of all the activities in the trip chain.

Preferably, the space-based vector for a user trip chain comprises a ratio of a length of the trip chain to a maximal length of the trip chain, a ratio of a radius of the trip chain to a length of the trip chain, a ratio of a distance a main activity departs from home to a length of the trip chain, a ratio of an average of distances between the activities to a length of the trip chain, and a standard deviation of distances between the activities.

Preferably, the time-based vector for a user activity comprises a ratio of start time of an activity to a whole day, a ratio of duration of an activity to a whole day, a ratio of a difference between start time of an activity and start time of the trip chain to duration of the trip chain, a ratio of duration of an activity to duration of the trip chain, a ratio of a difference between start time of an activity and end time of the previous activity to duration of the trip chain, a ratio of a difference between end time of an activity and start time of the next activity to duration of the trip chain, a ratio of duration of an activity to duration of a main activity, a ratio of a difference between start time of an activity and end time of a main activity to duration of the trip chain, and a ratio of a difference between start time of a main activity and end time of an activity to duration of the trip chain.

Preferably, the space-based vector for a user activity comprises a ratio of a distance an activity departs from home to a length of the trip chain, a ratio of distances between an activity and the previous activity to a length of the trip chain, a ratio of distances between an activity and the next activity to a length of the trip chain, a ratio of a difference between distance from an activity to home and distance from a main activity to home to a length of the trip chain, and a ratio of a difference between distance an activity departs from home and distance a main activity departs from home to a length of the trip chain.

Preferably, a classifier based on Support Vector Machine is employed to recognize the type of a user activity according to the feature vector so as to obtain features of the user behavior.

Preferably, the method for recognizing user behavior further comprises: associating behavior features of a user with the user's information through a user identification, and gathering feature data of a plurality of users in a certain region to obtain feature information of the region.

According to the present invention, it is possible to obtain the behavior and trip chain features of a single user based on the interpretation of the trajectory of the user. The deep level behavior features of the user can be obtained by establishing and analyzing proper feature vectors, such that the recognition result for each user can be more accurate and richer. In addition, with the present invention, it is possible to obtain behavior features for users in a city region by applying a classified statistical process to the features for users in the region, thereby improving the accuracy of the feature recognition for the city region.

### BRIEF DESCRIPTION OF THE DRAWINGS

The above and other features of the present invention will become more apparent from the following detailed descriptions with reference to the figures, in which:

FIG. 1 shows a schematic diagram of user trajectory distributed in time scope and region scope in prior art;

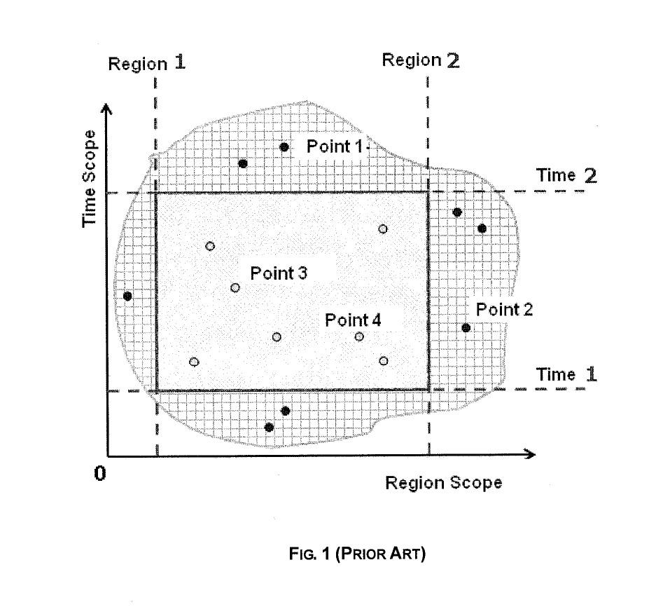

FIG. 2 shows a block diagram of a device for recognizing user behavior according to an embodiment of the present invention;

FIGS. 3 (a)-(d) show a schematic diagram of a user trip and activity process according to an embodiment of the present invention;

FIG. 4 shows a schematic diagram of extracting feature vectors for a user trip chain according to an embodiment of the present invention;

FIG. 5 shows a block diagram of a device for recognizing user behavior according to another embodiment of the present invention; and

FIG. 6 shows a flowchart of a method for recognizing user behavior according to an embodiment of the present invention.

### DETAILED DESCRIPTION OF PREFERRED EMBODIMENTS

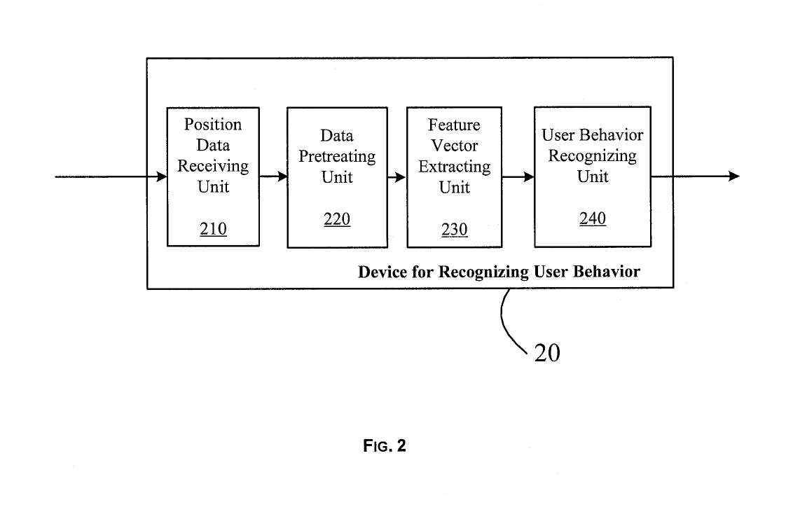

In the following, the principle and implementation of the present invention will become more apparent from the description of the specific embodiments of the present invention with reference to the drawings. It should be noted that the present invention is not limited to the specific embodiments as described later. Further, for the sake of simplicity, details of well known techniques irrelevant to the present invention will be omitted. FIG. 2 shows a block diagram of a device 20 for recognizing user behavior according to an embodiment of the present invention. As shown in FIG. 2, the device 20 for recognizing user behavior comprises a position data receiving unit 210, a data pretreating unit 220, a feature vector extracting unit 230 and a user behavior recognizing unit 240. The operations of the respective components of the device 20 for recognizing user behavior will be described in detail below.

The position data receiving unit 210 is configured to receive a large amount of user position data. For example, these data may include, but not limited to, data received via a GPS device of a user, data received via a cell phone positioning device, data received via a wireless positioning device, etc. Upon receipt of the user position data, the position data receiving unit 210 adjusts the user position data based on time to obtain user position data in time series. These position data are composed of a number of consecutive user trip chains and contain user identification information (e.g., a cell phone number of a user), geographical position coordinates (e.g., latitude and longitude) and time. Then, the position data receiving unit provides the adjusted user position data to the data pretreating unit 220.

The data pretreating unit 220 is configured to pretreat the user position data from the position data receiving unit 210, judge and obtain a user trip chain and user activity regions during the period of time, and obtain user activity optional positions in connection with POI information of a digital electronic map.

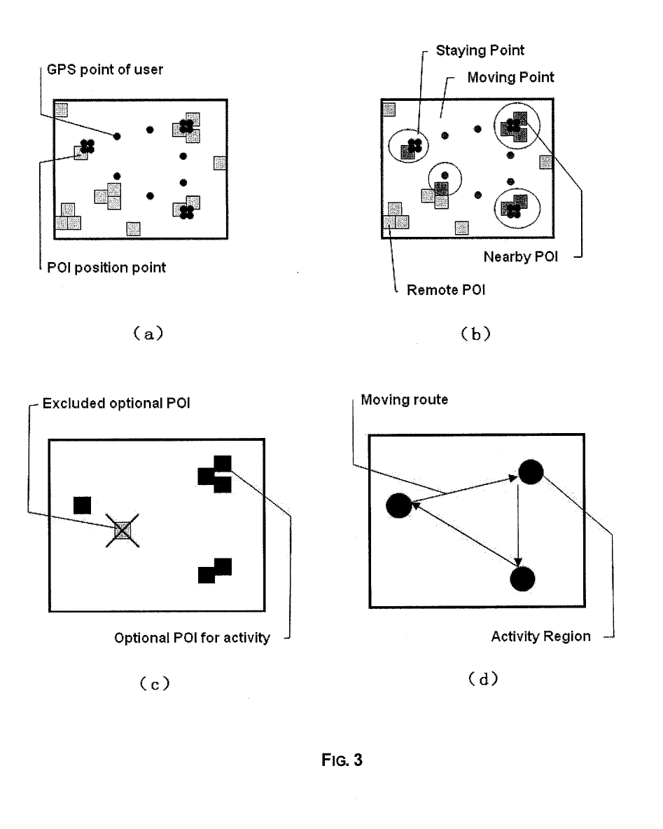

FIGS. 3 (a)-(d) show a schematic diagram of a user trip and activity process according to an embodiment of the present invention. In FIGS. 3(a) and 3(b), the circles represent the GPS positions of the user (GPS points) as received by the position data receiving unit 210, while the squares represent the POI position points on the digital electronic map. In addition, the remote POIs at the lower left corner of FIG. 3(b) represent POIs far away from the user. Such remote POIs are generally not used for recognizing user behavior since the user will not reach these POI position points in general.

During the process of identifying the user trip and activity positions, according to a particular judgment rule, points for which the time interval between two points in the user trajectory and within the positioning error range is larger than a threshold are judged as staying points, while points for which the time interval between two points in the user trajectory and within the positioning error range is smaller than a threshold are judged as moving points. For example, if the staying time between two points in the user trajectory is longer than 30 minutes, it is judged that the user is performing some activity (activity state). Otherwise, it may represent that the user is moving (movement state). With the above judgment, it is possible to determine the optional activity POIs for the user and exclude some optional POIs (e.g., the user simply passes through the POIs and does not perform any activity), as shown in FIG. 3(c) for example. Finally, the data pretreating unit 220 obtains the moving route (trip chain) and the activity regions for the user, as shown in FIG. 3(d).

Afterwards, the feature vector extracting unit 230 extracts a feature vector for the user trip chain and a feature vector for the activity itself. The feature vector for the user trip chain comprises a time-based vector CT and a space-based vector CS. The feature vector for activity itself comprises a time-based vector AT and a space-based vector AS. Each of these vectors will be described in detail in the following.

### Time-Based Vector CT for User Trip Chain

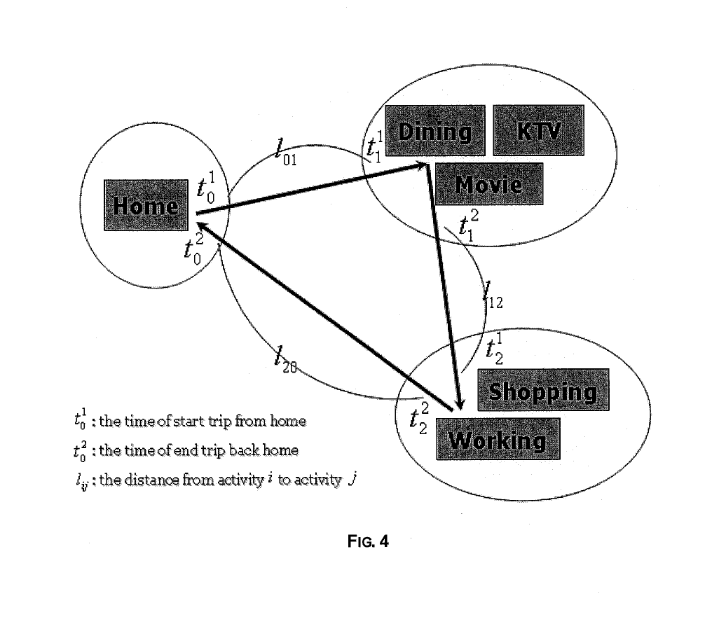

FIG. 4 shows a schematic diagram of extracting feature vectors for the user trip chain according to an embodiment of the present invention. Prior to feature extraction, the complete time and space information for the trip chain needs to be calculated and described, which comprises: trip chain start time t₀¹ representing the time when a resident starts his/her trip from home or a start position; trip chain end time t₀² representing the time when the resident returns home after finishing all activities; start time tᵢ¹ and end time tᵢ² of the i-th activity and a distance lᵢⱼ between the i-th activity and the j-th activity (as shown in FIG. 4). In a trip chain, the home can be regarded as an activity of rest at home with an activity number of 0.

In particular, time information for a trip chain comprises: trip time, activity time, start time of the trip chain, trip chain end time, duration of the trip chain, start time of a main activity, duration of the main activity, end time of the main activity and average activity time. Each of these variables is measured in units of minutes.

The feature vector CT extracted from the above time information for a trip chain comprises: (1) a ratio of start time of the trip chain to a whole day, CT₁; (2) a ratio of duration of the trip chain to a whole day, CT₂; (3) a ratio of start time of a main activity (i.e., the activity having the longest duration among all activities in the trip chain except for the activity of rest at home) to a whole day, CT₃; (4) a ratio of duration of a main activity to a whole day, CT₄; (5) a ratio of duration of all the activities to duration of the trip chain, CT₆; (6) a ratio of an average of duration of all the activities to duration of the trip chain, CT₆; (7) a standard deviation of a ratio of duration of distributed activities to duration of the trip chain, CT₇; and (8) a ratio of duration of a main activity to duration of all the activities in the trip chain, CT₈.

The equations for calculating the respective components, CT₁ to CT₈, of the vector CT are given below.

$$\begin{matrix}{CT}_{1} = \frac{{t}_{0}^{1}}{1440} & ( 1 ) \\ {CT}_{2} = \frac{{t}_{0}^{2} - {t}_{0}^{1}}{1440} & ( 2 ) \\ {CT}_{3} = \frac{{t}_{main}^{1}}{1440} & ( 3 ) \\ {CT}_{4} = \frac{{t}_{main}^{2} - {t}_{main}^{1}}{1440} & ( 4 ) \\ {CT}_{5} = \frac{{\sum }_{i} ( {t}_{i}^{2} - {t}_{i}^{1} )}{{t}_{0}^{2} - {t}_{0}^{1}} & ( 5 ) \\ {CT}_{6} = \frac{{\sum }_{i} ( {t}_{i}^{2} - {t}_{i}^{1} )}{( {t}_{0}^{2} - {t}_{0}^{1} ) \cdot N} & ( 6 ) \\ {CT}_{7} = \frac{{( \frac{1}{N} {\sum }_{i = 1}^{N} {( {t}_{i}^{2} - {t}_{i}^{1} - \frac{1}{N} {\sum }_{i = 1}^{N} ( {t}_{i}^{2} - {t}_{i}^{1} ) )}^{2} )}^{\frac{1}{2}}}{( {t}_{0}^{2} - {t}_{0}^{1} )} & ( 7 ) \\ {CT}_{8} = \frac{{t}_{main}^{2} - {t}_{main}^{1}}{{\sum }_{i} ( {t}_{i}^{2} - {t}_{i}^{1} )} & ( 8 )\end{matrix}$$

where t₀¹ denotes the start time of the trip chain, t₀² denotes the end time of the trip chain, tₘₐᵢₙ¹ denotes the start time of the main activity, tₘₐᵢₙ² denotes the end time of the main activity, tᵢ¹ denotes the start time of the i-th activity, tᵢ² denotes the end time of the i-th activity, and N denotes the number of activities except for the activity of rest at home.

### Space-Based Vector CS for User Trip Chain

The space information for a trip chain describes spatial component factors of the trip chain and reflects the spatial features of the user trip chain, including: a distance length of the trip chain; a distance between activities in the trip chain; a radius of the trip chain; a distance an activity departs from home; and a distance from an activity to home. The radius of the trip chain refers to a spatial span of the trip chain, i.e., the maximum distance between home and the activities in the trip chain. The distance an activity departs from home refers to the distance over which the user moves from home to the destination for the activity. The distance from an activity to home refers to the distance over which the resident moves from the activity position to the home after the end of the activity. The distance an activity departs from home and the distance from an activity to home can be identical to or different from each other. In order to describe the impact of the distance length of the resident trip chain on the contents of the activities, a maximum length of the trip chain is introduced. The magnitude of the length of the resident trip chain can be maintained to be the same as other feature vectors of the trip chain based on the ratio of the trip chain length to the maximum length of the trip chain.

The feature vector CS extracted from the spatial information of the trip chain comprises: (1) a ratio of a length of the trip chain to a maximal length of the trip chain (maximum value among all the trip chain lengths), CS₁; (2) a ratio of a radius of the trip chain to a length of the trip chain, CS₂; (3) a ratio of a distance a main activity departs from home to a length of the trip chain, CS₃; (4) a ratio of an average of distances between the activities (including home) to a length of the trip chain, CS₄; and (5) a standard deviation of distances between the activities, CS₅. The equations for calculating these components are given below.

$$\begin{matrix}{CS}_{1} = \frac{L}{{L}_{max}} & ( 9 ) \\ {CS}_{2} = \frac{L}{R} & ( 10 ) \\ {CS}_{3} = \frac{{l}_{main}^{1}}{L} & ( 11 ) \\ {CS}_{4} = \frac{1}{N + 1} & ( 12 ) \\ {CS}_{5} = {( \frac{1}{N + 1} {\sum }_{i = 0}^{N} {( {l}_{i , i + 1} - \frac{L}{N + 1} )}^{2} )}^{\frac{1}{2}} , & ( 13 )\end{matrix}$$

where L denotes the length of the trip chain and

$$L = {\sum }_{i = 0}^{N} {l}_{i , i + 1} , {l}_{N , N + 1} = {L}_{N , 0} ;$$

Lₘₐₓ denotes the maximum value among all the trip chain lengths; N denotes the number of activities except home; R denotes the radius of the trip chain and

$$R = {max}_{i = 1}^{N} ( min ( {l}_{i}^{2} , {l}_{i}^{2} ) ) ; {l}_{i}^{1}$$

denotes the distance the i-th activity departs from home; lᵢ² denotes the distance from the i-th activity to home; and lₘₐᵢₙ¹ denotes the distance the main activity departs from home.

### Time-Based Vector AT for Activity Itself

The time information for the activity itself describes temporal component factors for the activity itself and mainly comprises: absolute time feature; relative time feature; feature of time from/to a previous/subsequent activity; and feature of time from/to a main activity. The absolute time feature refers to start time, duration and end time in 24 hours of a day for an activity itself. The relative time feature refers to start time, duration and end time of an activity in a closed trip chain starting and ending with home.

The feature vector AT extracted from the time information for the activity itself comprises: (1) a ratio of start time of an activity to a whole day, AT₁; (2) a ratio of duration of an activity to a whole day, AT₂; (3) a ratio of a difference between start time of an activity and start time of the trip chain to duration of the trip chain, AT₃; (4) a ratio of duration of an activity to duration of the trip chain, AT₄; (5) a ratio of a difference between start time of an activity and end time of the previous activity to duration of the trip chain, AT₅; (6) a ratio of a difference between end time of an activity and start time of the next activity to duration of the trip chain, AT₆; (7) a ratio of duration of an activity to duration of a main activity, AT₇; (8) a ratio of a difference between start time of an activity and end time of a main activity to duration of the trip chain, AT_{S}; and (9) a ratio of a difference between start time of a main activity and end time of an activity to duration of the trip chain, AT₉. The vector AT for the i-th activity can be calculated according to the following equations.

$$\begin{matrix}{AT}_{1} = \frac{{t}_{i}^{1}}{1440} & ( 14 ) \\ {AT}_{2} = \frac{{t}_{i}^{2} - {t}_{i}^{1}}{1440} & ( 15 ) \\ {AT}_{3} = \frac{{t}_{i}^{1} - {t}_{0}^{1}}{{t}_{0}^{2} - {t}_{0}^{1}} & ( 16 ) \\ {AT}_{4} = \frac{{t}_{i}^{2} - {t}_{i}^{1}}{{t}_{0}^{2} - {t}_{0}^{1}} & ( 17 ) \\ {AT}_{5} = \frac{{t}_{i}^{1} - {t}_{i - 1}^{2}}{{t}_{0}^{2} - {t}_{0}^{1}} & ( 18 ) \\ {AT}_{6} = \frac{{t}_{i}^{2} - {t}_{i + 1}^{1}}{{t}_{0}^{2} - {t}_{0}^{1}} & ( 19 ) \\ {AT}_{7} = \frac{{t}_{i}^{2} - {t}_{i}^{1}}{{t}_{main}^{2} - {t}_{main}^{1}} & ( 20 ) \\ {AT}_{8} = \frac{{t}_{i}^{1} - {t}_{main}^{2}}{{t}_{0}^{2} - {t}_{0}^{1}} & ( 21 ) \\ {AT}_{9} = \frac{{t}_{main}^{1} - {t}_{i}^{2}}{{t}_{0}^{2} - {t}_{0}^{1}} & ( 22 )\end{matrix}$$

### Space-Based Vector AS for Activity Itself

The space information for the activity itself describes spatial component factors for the activity itself and mainly comprises: feature of distance an activity departs from home; feature of distance from an activity to home; distance from/to previous/subsequent activity; distance from/to a main activity; etc.

The feature vector AS extracted from the space information for the activity itself comprises: (1) a ratio of a distance an activity departs from home to a length of the trip chain, AS₁; (2) a ratio of distances between an activity and the previous activity to a length of the trip chain, AS₂; (3) a ratio of distances between an activity and the next activity to a length of the trip chain, AS₃; (4) a ratio of a difference between distance from an activity to home and distance from a main activity to home to a length of the trip chain, AS₄; and (5) a ratio of a difference between distance an activity departs from home and distance a main activity departs from home to a length of the trip chain. The vector AS for the i-th activity can be calculated according to the following equations.

$$\begin{matrix}{AS}_{1} = \frac{{l}_{i}^{1}}{L} & ( 23 ) \\ {AS}_{2} = \frac{{l}_{i - 1 , i}}{L} & ( 24 ) \\ {AS}_{3} = \frac{{l}_{i , i + 1}}{L} & ( 25 ) \\ {AS}_{4} = \frac{{l}_{i}^{2} - {l}_{main}^{2}}{L} & ( 26 ) \\ {AS}_{5} = \frac{{l}_{i}^{1} - {l}_{main}^{1}}{L} & ( 27 )\end{matrix}$$

where lᵢ¹ denotes the distance the i-th activity departs from home, lᵢ² denotes the distance from the i-th activity to home, L denotes the length of the trip chain, denotes the distance from the i-th activity to the its subsequent activity, lₘₐᵢₙ¹ denotes the distance the main activity departs from home and lₘₐᵢₙ² denotes the distance from the main activity to home.

Finally, the feature vector extracting unit 230 obtains a feature vector for recognizing a type of an activity in the trip chain: V=(CT,CS,AT,AS).

The user behavior recognizing unit 240 recognizes the type of a user activity according to the feature vector V as extracted by the feature vector extracting unit 230. In an embodiment of the present invention, a proper type can be selected from a number of optional activity types by using a classifier for activity type designed based on Support Vector Machine (SVM). For example, a one-to-one classifier can be used and an activity can be judged and recognized based on the obtained feature vector V. When there are two options in the option set of activity types, a corresponding pair wise classifier can be selected to judge the type of the activity. When there are more than two options in the option set, every two options are combined and a corresponding pair wise classifier is selected to judge and vote for each activity. In this case, the type obtaining the most votes is selected as the final type. As an alternative, it is also possible to give a percentage for each optional type in a vote percentage manner. Finally, the user behavior recognizing unit 240 can obtain behavior features (trip features and activity features) of a single user, as shown in Table 4 below.

TABLE 4

| Trip Features | Activity Features |
|---|---|
| 7 am-9 am on workday: From | Workday: at work place in the |
| suburb to CBD via Highway A | morning |
| 6 pm-7 pm on workday: From CBD | Workday: at dining room at noon |
| to shop via Railway Line 2 | |
| 9 pm-10 pm on workday: From shop | Weekend: at KTV in the evening |
| to suburb via Highway B | |
| | Workday: at home at night |

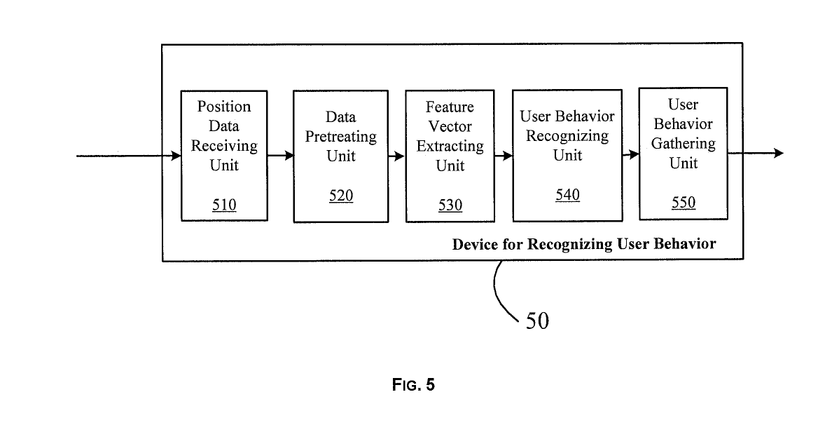

FIG. 5 shows a block diagram of a device 50 for recognizing user behavior according to another embodiment of the present invention. As shown in FIG. 5, the device 50 for recognizing user behavior comprises a position data receiving unit 510, a data pretreating unit 520, a feature vector extracting unit 530, a user behavior recognizing unit 540 and a user behavior gathering unit 550. The units 510-540 of the device 50 for recognizing user behavior are similar to the units 210-240 of the device 20 for recognizing user behavior as shown in FIG. 2, respectively. Thus, for the sake of conciseness, only the user behavior gathering unit 550 will be detailed in the following.

The user behavior gathering unit 550 associates behavior features of a single user with the user's information (e.g., the above Table 2) through a user identification, and classifies and gathers feature data of a plurality of users in a certain region to obtain feature information of the region. An example of the regional feature information obtained by the gathering operation of the user behavior gathering unit 550 is shown in Table 5.

TABLE 5

| Item | Statistical Result | Regional Feature | . . . |
|---|---|---|---|
| Age | 16-20: 2 | Young people favor | . . . |
| | 20-30: 0 | | |
| Gender | Female: 2 | Female favor | . . . |
| | Male: 0 | | |
| Type of Activity | KTV: 34% | Shopping is the first | . . . |
| | Movie: 25% | choice and KTV is the | |
| | Shopping: 40% | second. | |
| Type of Trip | Railway: 60% | Railway is the first | . . . |
| | Highway: 25% | choice and Highway is | |
| | | the second. | |
| . . . | . . . | . . . | . . . |

It can be seen that, when compared with the prior art, the regional feature information according to the present invention is more specific, such that the accuracy of city region feature recognition can be improved.

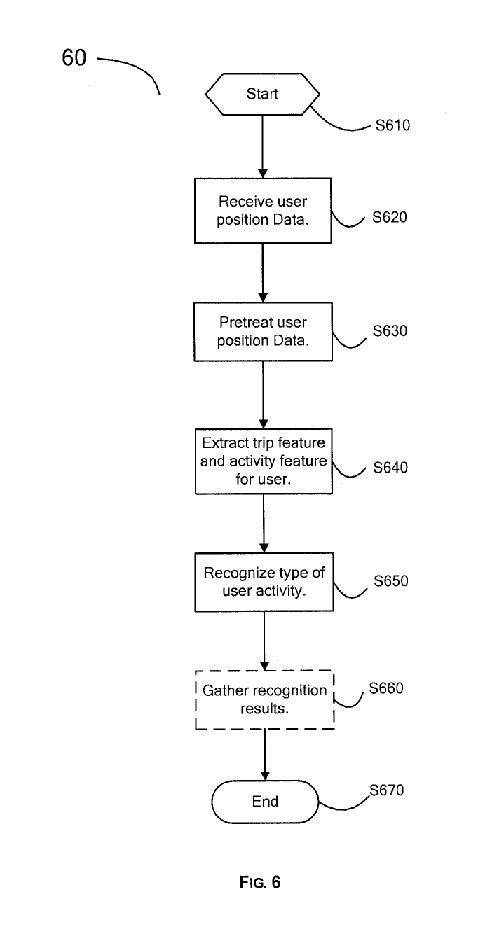

FIG. 6 shows a flowchart of a method 60 for recognizing user behavior according to an embodiment of the present invention. The method 60 starts with step S610.

At step S620, user position data are received. For example, these data may be data received via a GPS device of a user, data received via a cell phone positioning device, data received via a wireless positioning device, etc. Upon receipt of the user position data, the user position data are adjusted based on time to obtain user position data in time series.

At step S630, the user position data in time series are pretreated, a user trip chain and user activity regions within a particular time period are judged and obtained, and user activity optional positions are obtained in connection with Point of Interest information of a digital electronic map.

At step S640, a trip feature vector and an activity feature vector for a user are extracted. Herein, the trip feature vector comprises a time-based vector CT and a space-based vector CS; the activity feature vector comprises a time-based vector AT and a space-based vector AS. The detailed extraction process has been described above with respect to the feature vector extracting unit 230 of FIG. 2. Then, a feature vector for recognizing a type of a user activity is obtained: V=(CT,CS,AT,AS).

At step S650, the type of the user activity is recognized. Preferably, a proper type can be selected from a number of optional activity types by using a classifier for activity type designed based on Support Vector Machine (SVM). For example, a one-to-one classifier can be used and an activity can be judged and recognized based on the obtained feature vector V. When there are two options in the option set of activity types, a corresponding pair wise classifier can be selected to judge the type of the activity. When there are more than two options in the option set, every two options are combined and a corresponding pair wise classifier is selected to judge and vote for each activity. In this case, the type obtaining the most votes is selected as the final type. As an alternative, it is also possible to give a percentage for each optional type in a vote percentage manner. Finally, the behavior features (trip features and activity features) of a single user can be obtained.

Alternatively, the method 60 may comprise a step S660 (shown in dashed block). At step S660, the behavior features of a single user are associated with the user's information through a user identification, and feature data of a plurality of users in a certain region can be classified and gathered to obtain feature information of the region (e.g., as shown in Table 5).

Finally, the method 60 ends at step S670. If the optional step S660 is not performed, after step S650, the method 60 directly proceeds with step S670 and ends.

According to the present invention, a large amount of historical user data can be processed in a centralized manner. The deep level behavior features of the user can be obtained by establishing and analyzing proper feature vectors, such that the recognition result for the trajectory data of each user can be more accurate and richer. In addition, according to the present invention, it is possible to obtain the behavior of a single user based on the interpretation of the trajectory of the user. With the present invention, it is possible to obtain behavior features for users in a city region by applying a classified statistical process to the features for users in the region, thereby improving the accuracy of the feature recognition for the city region.

While the present invention has been described above with reference to the preferred embodiments thereof, it can be appreciated by those skilled in the art that various modifications, alternatives and changes may be made without departing from the spirit and scope of the present invention. Therefore, the present invention is not limited by the above embodiments, but by the claims as attached and equivalent thereof.

What is claimed is:

1. A device for recognizing user behavior, the device comprising:
a position data receiving unit configured to receive user position data and adjust the data based on time to obtain user position data in time series;
a data pretreating unit configured to pretreat the user position data in time series;
a feature vector extracting unit configured to extract a feature vector for recognizing a type of a user activity according to the pretreated user position data; and
a user behavior recognizing unit configured to recognize the type of a user activity according to the feature vector extracted by the feature vector extracting unit and to obtain behavior features of the user.

2. The device according to claim 1, wherein the user position data in time series comprise user identification information, geographical position information, and time information.

3. The device according to claim 1, wherein the data pretreating unit is configured to obtain a user trip chain and user activity regions from the user position data in time series, and to obtain user activity optional positions in connection with Point of Interest information of a digital electronic map.

4. The device according to claim 1, wherein the feature vector extracted by the feature vector extracting unit comprises time-based and space-based vectors for a user trip chain and time-based and space-based vectors for a user activity.

5. The device according to claim 4, wherein the time-based vector for a user trip chain comprises a ratio of start time of the trip chain to a whole day, a ratio of duration of the trip chain to a whole day, a ratio of start time of a main activity to a whole day, a ratio of duration of a main activity to a whole day, a ratio of duration of all the activities to duration of the trip chain, a ratio of an average of duration of all the activities to duration of the trip chain, a standard deviation of a ratio of duration of distributed activities to duration of the trip chain, and a ratio of duration of a main activity to duration of all the activities in the trip chain.

6. The device according to claim 4, wherein the space-based vector for a user trip chain comprises a ratio of a length of the trip chain to a maximal length of the trip chain, a ratio of a radius of the trip chain to a length of the trip chain, a ratio of a distance a main activity departs from home to a length of the trip chain, a ratio of an average of distances between the activities to a length of the trip chain, and a standard deviation of distances between the activities.

7. The device according to claim 4, wherein the time-based vector for a user activity comprises a ratio of start time of an activity to a whole day, a ratio of duration of an activity to a whole day, a ratio of a difference between start time of an activity and start time of the trip chain to duration of the trip chain, a ratio of duration of an activity to duration of the trip chain, a ratio of a difference between start time of an activity and end time of the previous activity to duration of the trip chain, a ratio of a difference between end time of an activity and start time of the next activity to duration of the trip chain, a ratio of duration of an activity to duration of a main activity, a ratio of a difference between start time of an activity and end time of a main activity to duration of the trip chain, and a ratio of a difference between start time of a main activity and end time of an activity to duration of the trip chain.

8. The device according to claim 4, wherein the space-based vector for a user activity comprises a ratio of a distance an activity departs from home to a length of the trip chain, a ratio of distances between an activity and the previous activity to a length of the trip chain, a ratio of distances between an activity and the next activity to a length of the trip chain, a ratio of a difference between distance from an activity to home and distance from a main activity to home to a length of the trip chain, and a ratio of a difference between distance an activity departs from home and distance a main activity departs from home to a length of the trip chain.

9. The device according to claim 1, wherein the user behavior recognizing unit comprises a classifier based on Support Vector Machine.

10. The device according to claim 1, further comprising:
a user behavior gathering unit configured to associate behavior features of a user with the user's information through a user identification, and to gather feature data of a plurality of users in a certain region to obtain feature information of the region.

11. A method for recognizing user behavior, the method comprising:
receiving user position data and adjusting the data based on time to obtain user position data in time series;
pretreating the user position data in time series;
extracting a feature vector for recognizing a type of a user activity according to the pretreated user position data; and
recognizing the type of a user activity according to the feature vector so as to obtain behavior features of the user.

12. The method according to claim 11, wherein the user position data in time series comprise user identification information, geographical position information, and time information.

13. The method according to claim 11, wherein the step of pretreating comprises obtaining a user trip chain and user activity regions from the user position data in time series, and obtaining user activity optional positions in connection with Point of Interest information of a digital electronic map.

14. The method according to claim 11, wherein the feature vector comprises time-based and space-based vectors for a user trip chain and time-based and space-based vectors for a user activity.

15. The method according to claim 14, wherein the time-based vector for a user trip chain comprises a ratio of start time of the trip chain to a whole day, a ratio of duration of the trip chain to a whole day, a ratio of start time of a main activity to a whole day, a ratio of duration of a main activity to a whole day, a ratio of duration of all the activities to duration of the trip chain, a ratio of an average of duration of all the activities to duration of the trip chain, a standard deviation of a ratio of duration of distributed activities to duration of the trip chain, and a ratio of duration of a main activity to duration of all the activities in the trip chain.

16. The method according to claim 14, wherein the space-based vector for a user trip chain comprises a ratio of a length of the trip chain to a maximal length of the trip chain, a ratio of a radius of the trip chain to a length of the trip chain, a ratio of a distance a main activity departs from home to a length of the trip chain, a ratio of an average of distances between the activities to a length of the trip chain, and a standard deviation of distances between the activities.

17. The method according to claim 14, wherein the time-based vector for a user activity comprises a ratio of start time of an activity to a whole day, a ratio of duration of an activity to a whole day, a ratio of a difference between start time of an activity and start time of the trip chain to duration of the trip chain, a ratio of duration of an activity to duration of the trip chain, a ratio of a difference between start time of an activity and end time of the previous activity to duration of the trip chain, a ratio of a difference between end time of an activity and start time of the next activity to duration of the trip chain, a ratio of duration of an activity to duration of a main activity, a ratio of a difference between start time of an activity and end time of a main activity to duration of the trip chain, and a ratio of a difference between start time of a main activity and end time of an activity to duration of the trip chain.

18. The method according to claim 14, wherein the space-based vector for a user activity comprises a ratio of a distance an activity departs from home to a length of the trip chain, a ratio of distances between an activity and the previous activity to a length of the trip chain, a ratio of distances between an activity and the next activity to a length of the trip chain, a ratio of a difference between distance from an activity to home and distance from a main activity to home to a length of the trip chain, and a ratio of a difference between distance an activity departs from home and distance a main activity departs from home to a length of the trip chain.

19. The method according to claim 11, wherein a classifier based on Support Vector Machine is employed to recognize the type of a user activity according to the feature vector so as to obtain features of the user behavior.

20. The method according to claim 11, further comprising:
associating behavior features of a user with the user's information through a user identification, and
gathering feature data of a plurality of users in a certain region to obtain feature information of the region.
